(19) United States
(12) Patent Application Publication
(10) Pub. No.: US 2019/0203759 A1
(43) Pub. Date: Jul. 4, 2019

(54) Suction Cup Attachment Method For Flexible Materials

(71) Applicant: Jacob Zimmerman, San Rafael, CA (US)

(72) Inventor: Jacob Zimmerman, San Rafael, CA (US)

(21) Appl. No.: 15/856,781

(22) Filed: Dec. 28, 2017

(51) Int. Cl. F16B 47/00; F16B 23/00; A47L 13/51

(52) U.S. Cl. CPC F16B 47/00; A47L 13/51; F16B 23/00

(57) ABSTRACT

A suction cup attachment method for flexible materials with a flexible cup member, a stem member, a flexible flange member. The cup member forms a standard suction cup. The stem member is integrally and centrally attached on one end to the underside of the flexible cup member. The stem member is integrally and centrally attached at the opposite end to the flexible flange member. The flexible flange member includes a plurality of apertures for allowing adhesive material to flow through the flexible flange member to mate a first flexible panel member to a second flexible panel member. An alternate embodiment includes the stem member being threaded and having no flange member.

### CROSS REFERENCE TO RELATED APPLICATIONS

Provisional patent application No. 62/603,126

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of holding devices and more specifically to a suction cup attachment method for flexible materials. suction cups are well known for being in a way to removably attach an item to a smooth, non-porous surface. Suction cups have been added to such items as pen holders so that the pen holder can be applied, via suction cup, to a surface such as a refrigerator, and can hold a pen so that it is handy for writing shopping lists and the like. Suction cups have also been used in various other types of holding devices, such as a sponge holder described in Virgo Ballares 1994 U.S. Pat. No. 5,277,389 where a rigid plate and support shelf includes a plurality of suction cups to hold it to a bathroom wall. However, there is a deficiency in the prior technology in that no provision is made for attaching a suction cup to a flexible material unless the material is the exact same type as the suction cup and molded as one piece. Additionally, no provision is made for attaching a suction cup to a flexible material and having the top edge of the suction cup be approximately level with the top surface of the flexible material.

### BRIEF SUMMARY OF THE INVENTION

The primary object of the invention is to provide a suction cup device that is capable of being attached to a flexible material.

Another object of the invention is to provide a suction cup device that includes a flange that can be trapped between two flexible materials.

Another object of the invention is to provide a suction cup whose flange includes a plurality of apertures to further facilitate the attachment by allowing adhesive to flow through the apertures to connect a bottom flexible layer to a top flexible layer.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a suction cup attachment method for flexible materials comprising: a flexible cup member, a stem member, a flexible flange member, said cup member forming a standard suction cup, said stem member integrally and centrally attached on one end to the underside of said flexible cup member, said stem member integrally and centrally attached at the opposite end to said flexible flange member, and said flexible flange member including a plurality of apertures for allowing adhesive material to flow through said flexible flange member to mate a first flexible panel member to a second flexible panel member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view showing how the flange of the suction cup can be trapped between two layers of flexible material.

FIG. 3 is a perspective view of a sponge with a suction cup fixed in place.

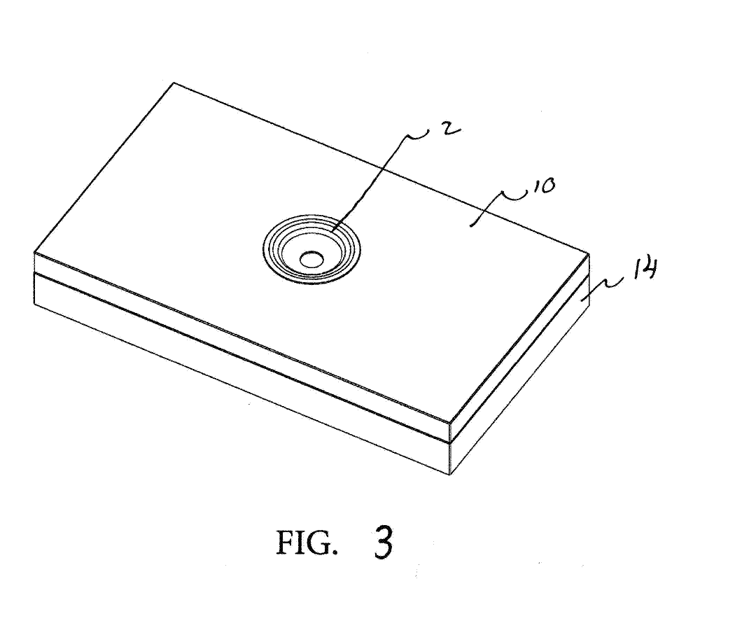

FIG. 4 is a section view of the sponge and suction cup assembly.

FIG. 5 is a bottom view of the flange portion of the suction cup assembly.

FIG. 6 is a top view of an alternate embodiment of the invention.

FIG. 7 is a perspective view of the alternate embodiment of the invention.

FIG. 8 is a perspective view showing a threading tool for the alternate embodiment of the invention.

FIG. 9 is an exploded view of the alternate embodiment of the invention.

FIG. 10 is a side section view of the alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

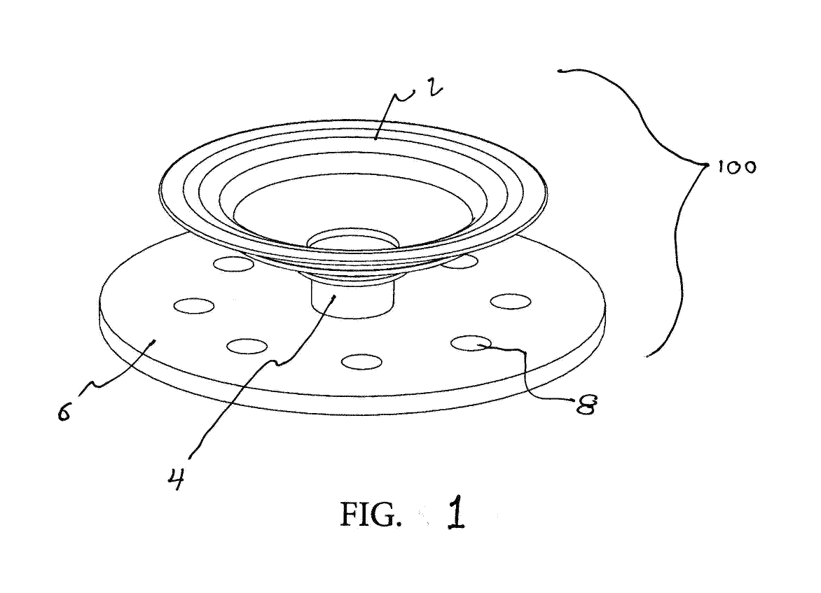

Referring now to FIG. 1 we see a perspective view of the suction cup assembly of the present invention 100. The invention is comprised of three parts. A flexible cup member 2, a stem member 4 and a flexible flange member 6. The flange member includes a plurality of apertures 8 for allowing adhesive to flow through from a top panel to a bottom panel as will be discussed below.

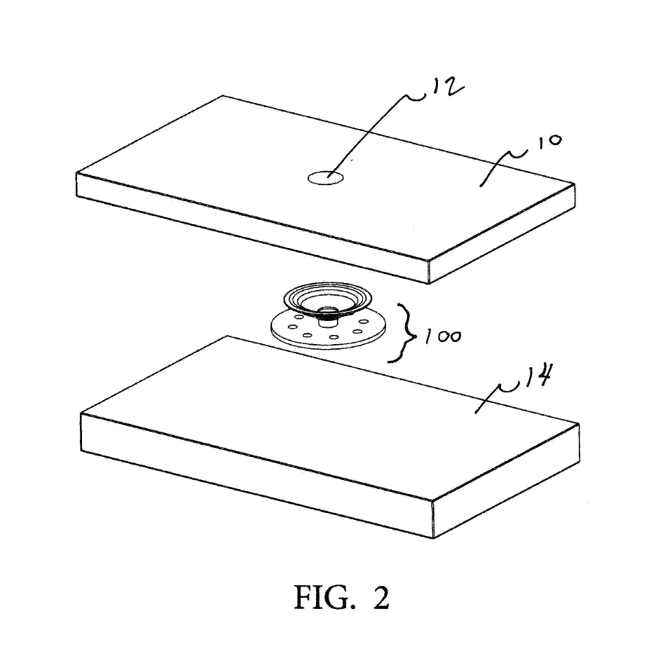

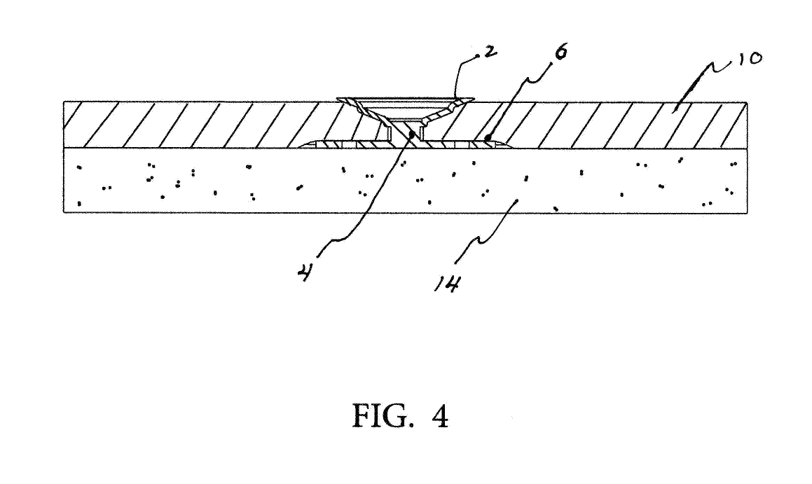

FIG. 2 is an exploded view showing a flexible scrubber panel 10 and a sponge panel 14 with the invention 100 shown between them. The scrubber panel 10 includes a slit or hole 12 that allows the flange 6 of the suction cup assembly to be folded and inserted into and through the hole 12 so that it can reside between the scrubber panel 10 and the sponge panel 14 as shown in the section view in FIG. 4. When the scrubber panel 10 and the sponge panel 14 are fused together via traditional adhesive means, the flange 6 is trapped between the two panels 10, 14 so that the top edge of the suction cup 2 is approximately flush with the top surface of the scrubbing panel 10. In this way, the suction cup 2 does not impinge on the scrubbing panel when in use during the cleaning dishes, pots or other items.

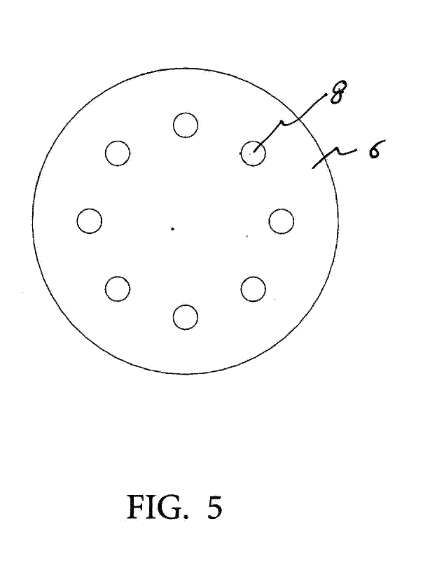

FIG. 5 is a bottom view of the suction cup assembly 100 showing flange 6 with a plurality of apertures 8 that allow for more secure adhesion of the scrubber panel 10 to the sponge panel 14.

It should be noted that the suction cup assembly of the present invention 100 can be used in other products besides a sponge. For example, the flange 6 can be trapped between the outer flexible layer of a child's toy or doll, and the inner layer of flexible material such as poly-foam. Adhesive or other standard fastening means can be used to cause the underside of the outer flexible layer to be adhered to the top side of the inner flexible layer.

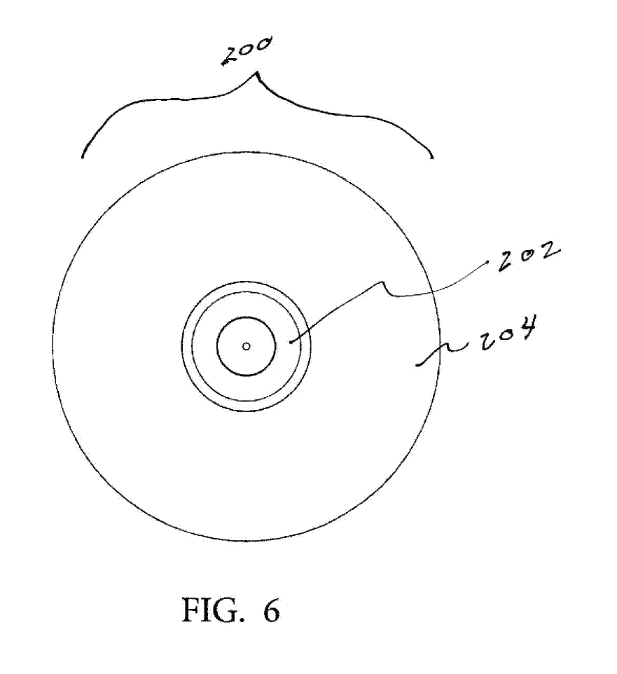

FIG. 6 is a top view of an alternate embodiment of the invention 200. This embodiment shows a round design, which can also be applied to the first embodiment. It includes a centrally located suction cup 202 embedded into the scrubber panel 204 of the sponge.

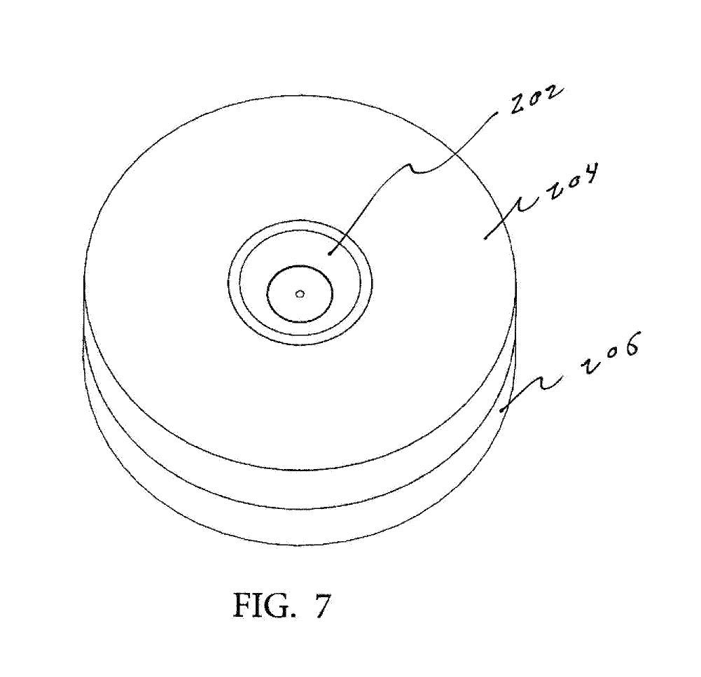

FIG. 7 is a perspective view of the alternate embodiment 200 showing both the scrubber panel 204 and the sponge panel 206 which are bonded to each other.

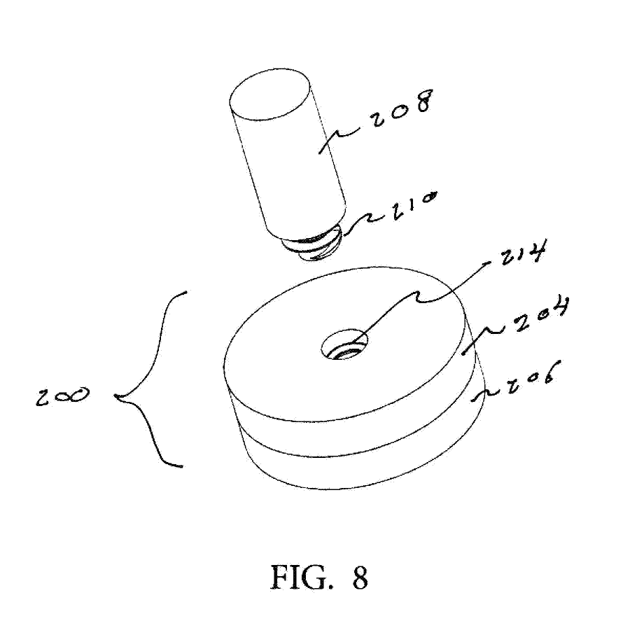

FIG. 8 shows the alternate embodiment with the suction cup 202 removed. An aperture 214 in the center of the sponge is giving female threads by use of a rigid threading tool which includes a handle portion 208 and a thread forming portion 210. The thread forming portion 210 is screwed into the aperture 214 to imprint the thread design into the inside diameter of the aperture 214.

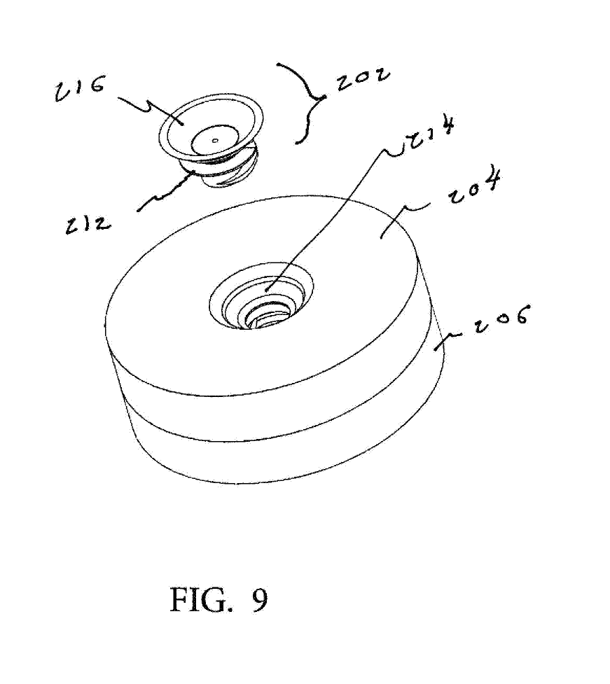

FIG. 9 is an exploded view of the alternate embodiment 200 showing the suction cup 202 a having a suction head 216 and where the stem member 4 is now a threaded base 212. Flange member 6 has been eliminated. During assembly, the threaded base 212 is screwed into aperture 214 to lock it in place. A flexible food grade adhesive may also be used to further lock the threads 212 into aperture 214. The dense consistency of the scrubbing panel 204 allows the threads 212 remain engaged during use. The threads are relatively large, approximately three sixteenths of an inch from the center post to the outer edge, allowing them to securely retain the scrubbing panel material. It should be noted that although two threads are shown, the number of threads can be increased to three or four or more and remain within the scope of the present invention.

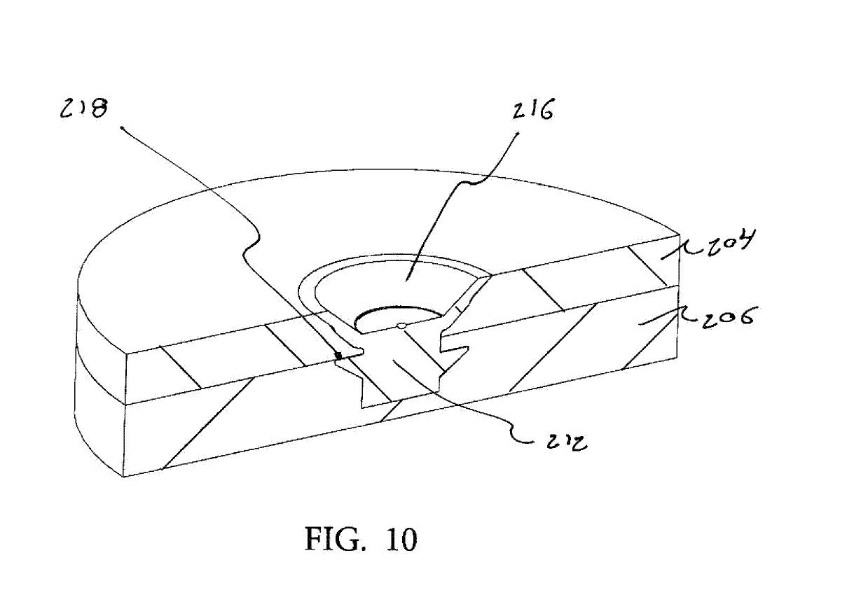

FIG. 10 is a side section view of the alternate embodiment of the invention 200 showing the threads 212 of the suction cup securely embedded in the scrubber panel 204 of the invention. Ideally the uppermost thread 218 lands just below the bottom of scrubber panel 204

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. suction cup attachment method for flexible materials comprising:
a flexible cup member;
a stem member;
a flexible flange member;
said cup member forming a standard suction cup;
said stem member integrally and centrally attached on one end to the underside of said flexible cup member;
said stem member integrally and centrally attached at the opposite end to said flexible flange member; and
said flexible flange member including a plurality of apertures for allowing adhesive material to flow through said flexible flange member to mate a first flexible panel member to a second flexible panel member.

2. A suction cup attachment method for flexible materials as claimed in claim 1 wherein said flexible flange member can be folded and inserted into a slit in a first flexible panel member allowing a second flexible panel member to be adhesively joined to said first flexible panel member causing said flexible flange to be trapped between said first flexible panel and said second flexible panel.

3. A suction cup attachment method for flexible materials as claimed in claim 2 wherein the top edge of said flexible cup member is approximately level with the top surface of said first flexible panel member.

4. A suction cup attachment method for flexible materials as claimed in claim 2 wherein said first flexible panel member is a scrubbing pad and said second flexible panel member is a sponge.

5. A suction cup attachment method for flexible materials as claimed in claim 2 wherein said first flexible panel member is the outer surface of a toy or stuffed animal and said second flexible panel member is the inner surface of said toy or stuffed animal.

6. An alternate embodiment of the present invention where said suction cup wherein said stem member includes no flange member and instead includes a male threaded portion that is capable of being threadably inserted into said aperture at the center of said first flexible panel of said sponge thereby securely retaining said suction cup to said first flexible panel.

7. A rigid threading tool, comprised of a handle portion and an attached male thread portion, for use with said alternate embodiment of the present invention causing said aperture of said first flexible panel to have female threads that can accept the said male threads of said base portion of said suction cup.
